(19) United States
(12) Patent Application Publication
(10) Pub. No.: US 2017/0368382 A1
(43) Pub. Date: Dec. 28, 2017

(54) FUNCTIONAL PROTECTIVE MATERIAL WITH A REACTIVELY FINISHED MEMBRANE AND PROTECTIVE CLOTHING PRODUCED THEREWITH

(71) Applicant: BLÜCHER GMBH, Erkrath (DE)

(72) Inventors: Hasso VON BLÜCHER, Erkrath (DE); Bertram BÖHRINGER, Wuppertal (DE)

(73) Assignee: BLÜCHER GMBH, Erkrath (DE)

(21) Appl. No.: 15/644,125

(22) Filed: Jul. 7, 2017

Related U.S. Application Data
(63) Continuation of application No. 12/811,618, filed on Dec. 17, 2010, now abandoned.

(30) Foreign Application Priority Data
Jan. 4, 2008 (DE) 102008003253.0
Mar. 6, 2008 (DE) 102008012937.2

(51) Int. Cl. A62B 17/00; B01D 39/20; A43B 1/00; A43B 7/12; A43B 23/02; A43B 23/07; A62D 3/176; A62D 5/00; B01D 39/08; B01D 39/16; B32B 27/12; A62D 101/20; A62D 101/08; A62D 101/28; A62D 101/22

(52) U.S. Cl. CPC A62B 17/006; B32B 27/12; B01D 39/2058; A43B 1/00; A43B 7/125; A43B 23/0235; A43B 23/07; A62D 3/176; A62D 5/00; B01D 39/083; B01D 39/1692; B01D 39/2065; B01D 2239/0407; B01D 2325/10; Y10T 428/249921; A62D 2101/20; A62D 2101/08; A62D 2101/28; B01D 2239/0428; B01D 2239/0442; B01D 2239/0464; B01D 2239/0609; B01D 2239/0636; B01D 2239/065; B01D 2239/0681; B01D 2239/0686; B01D 2239/1208; A62D 2101/22

(57) ABSTRACT

The object of the invention is a functional protective material, especially with the function of protecting against chemical and/or biological poisons and/or noxious materials, such as combat agents, wherein the functional protective material comprises a multilayer construction. The multilayer construction has a two-dimensional backing material, especially a textile backing material and a membrane, which is assigned to the backing material and, in particular, is connected therewith. The membrane is provided with a reactive finish, especially with a component having catalytic activity preferably with respect to chemical and/or biological poisons and/or noxious matter. The adsorption filter material is suitable particularly for use in ABC protection objects (such as ABC protective clothing).

### CROSS-REFERENCES TO RELATED APPLICATIONS

This patent application is a continuation of U.S. application Ser. No. 12/811,618, entitled “FUNCTIONAL PROTECTIVE MATERIAL WITH A REACTIVELY FINISHED MEMBRANE AND PROTECTIVE CLOTHING PRODUCED THEREWITH” filed on Dec. 17, 2010, which claims priority to PCT/EP2008/009244, filed Nov. 3, 2008, and to German Applications No. DE 10 2008 003 253.0 filed Jan. 4, 2008, and DE 10 2008 012 937.2 filed Mar. 6, 2008, and incorporates all by reference herein, as if each one were independently incorporated in its entirety.

### BACKGROUND OF THE INVENTION

The present invention relates to a functional protective material, more particularly having protective functions with regard to chemical and/or biological poisons and/or noxiants, having a multilayered construction and containing a membrane having reactive additization. The present invention further relates to a reactive-additization membrane as such. Moreover, the present invention relates to the use of the present invention protective material and/or of the present invention membrane in the manufacture of protective materials of any kind (such as, for example, protective suits, protective gloves, protective shoes and other protective apparel pieces and also protective covers, for example for medical transports, tents, sleeping bags and the like). Finally, the present invention relates to protective materials as such that include the present invention protective material or to be more precise the present invention membrane and/or were obtained using the present invention protective material or to be more precise the present invention membrane. The present invention protective material and/or the present invention membrane are thus useful not only for the military sector but also for the civil sector, more particularly for NBC deployment.

There are a series of materials which are taken up by the skin and lead to serious physical harm (noxae). Examples include the visicatory Hd (interchangeably referred to as Yellow Cross and mustard gas) and the nerve agent sarin. People likely to come into contact with such poisons must wear suitable protective apparel or be protected against these poisons by suitable protective materials. In addition, people likely to come into contact with other toxic substances also need to be protected through appropriate protective apparel and/or materials.

Protective suits known for this purpose include for example air and water vapor impervious protective suits that are equipped with a rubber layer impervious to chemical poisons. The disadvantage here is that these suits very quickly lead to a heat build-up, since they are air and water vapor impervious. Other disadvantages here include the nonexistent breathability and also the nonexistent exchange of air.

Protective suits against chemical warfare agents that are intended for prolonged deployment under a variety of conditions, however, must not lead to a heat build-up for the wearer. To this end, air and water vapor pervious protective suits are known in the prior art, which offer a relatively high wearing comfort. These kinds of air and water vapor pervious protective suits often feature an adsorptive filtering layer of activated carbon, which permanently binds the chemical poisons. The advantage of such systems is that the activated carbon is also accessible at the inside surface, providing for rapid adsorption of poisons that have penetrated at damaged or otherwise nontight places. Under extreme conditions, more particularly when a drop of a thickened poisonous or warfare agent lands on the protective suit material from a comparatively great height and strikes through to the activated carbon, however, the layer of activated carbon can be locally overtaxed. In addition, protective suits of this kind often only offer an inadequate protective performance in respect of biological noxiants.

Permeable, adsorptive filtering systems, more particularly based on activated carbon, are therefore often additized with a catalytically active component by impregnating the activated carbon for example with a biocidal or biostatic catalyst, more particularly based on metals or metal compounds.

A protective material of this kind is described for example in DE 195 19 869 A1, which contains a multi-ply, textile, gas-pervious filtering material comprising an adsorption layer based on activated carbon, more particularly in the form of carbonized fibers, the activated carbon being impregnated with a catalyst selected from the group consisting of copper, cadmium, platinum, palladium, mercury and zinc, in amounts ranging from 0.05 % to 12 % by weight, based on the activated-carbon material. The disadvantage with this protective material or filtering system is the fact that impregnation with the catalyst destroys a portion of the adsorption capacity needed for adsorbing and thus disarming chemical noxiants. The impregnating operation thus has an adverse impact on the performance capability of the activated carbon used. Furthermore, impregnating the activated-carbon material is relatively costly and often compromises the manufacturing operation for the activated carbon, more particularly the activating step. Moreover, impregnation with the catalyst does not always provide the desired efficacy with regard to biological noxiants and/or microorganisms, and the problem of poisonous or warfare agents striking through at high concentrations is also not always solved by this principle. Finally, the impregnating operation requires relatively large amounts of the catalyst material.

The prior art further includes protective suits engineered to be air impervious yet water vapor pervious, or breathable. Protective suits of this kind generally include a membrane that acts as an air impervious yet water vapor pervious or breathable blocking layer with regard to poisonous and/or warfare agents. However, protective suits featuring such membrane systems do not always provide a sufficient protective performance. In addition, the protective membranes used in this context in the prior art are often such blocking-layer membranes which do not always ensure adequate breathability, more particularly not under deployment conditions involving physical exertion, and therefore the wearing comfort is occasionally compromised as a consequence of the lack of air exchange and/or the lack of emission of water vapor through the protective material. In addition, protective materials used in the prior art may also include a microporous membrane. Membrane systems of this kind generally have an elevated ability to transmit water vapor, but do have the decisive disadvantage that the pores in the microporous membrane system may occasionally be pervious to small molecules in particular, including for example the toxic substances hydrocyanic acid and chlorine gas. Membrane systems of this kind are thus not always able to provide effective protection with regard to noxiants and/or poisons in the form of small (gas) molecules in particular.

### BRIEF SUMMARY OF THE INVENTION

The present invention therefore has for its object to provide a protective material whereby the above-described disadvantages of the prior art are at least substantially obviated or at least ameliorated. More particularly, such a protective material should be suitable for the manufacture of NBC protective articles of any kind, for example NBC protective apparel and the like.

The present invention further has for its object to provide a protective material that combines a high water vapor transmission rate and hence a high wearing comfort with an effective protective performance with regard to chemical and/or biological poisons and noxiants, such as warfare agents.

The present invention yet further has for its object to provide a protective material that is more particularly suitable for use in protective articles (such as, for example, protective suits, protective gloves, protective shoes and other protective apparel pieces and also protective covers, sleeping bags and the like) and ensures high wearing comfort when put to such use.

To achieve this object, the present invention provides—as per a first aspect of the present invention—a functional protective material, more particularly having protective functions with regard to chemical and/or biological toxicants and/or noxiants, such as warfare agents, as per claim 1, wherein the functional protective material of the present invention includes a membrane having reactive additization. Further advantageous embodiments of the protective material of the present invention form the subject matter of respective subclaims.

The present invention further provides—as per a next aspect of the present invention—the present invention membrane as such, which is provided with a reactive additization. Further advantageous embodiments of the membrane of the present invention form the subject matter of the respective subclaim.

The present invention further provides—as per a next aspect of the present invention—the use of the present invention functional protective material and/or of the present invention membrane in the manufacture of protective articles of any kind, such as protective suits, protective gloves, protective footwear and other protective apparel pieces and also protective covers, sleeping bags, tents and the like, preferably for NBC deployment and that both for civil and military applications.

The present invention yet further provides—as per yet another aspect of the present invention—protective articles, more particularly protective suits, protective gloves, protective footwear and other protective apparel pieces and also protective covers, sleeping bags and the like, obtained using the protective material of the present invention and/or using the membrane of the present invention, or which include the protective material of the present invention and/or the membrane of the present invention.

It will be understood that elaborations, embodiments, advantages and the like that are recited herein in relation to one aspect of the invention only to avoid repetition do of course also apply correspondingly in relation to the other aspects of the invention.

### BRIEF DESCRIPTION OF THE DRAWINGS

FIG. 1 provides a schematic sectional view of the layered construction according to one embodiment of the present invention illustrating elements which include a membrane, a supporting material, an adsorption layer and an inner layer.

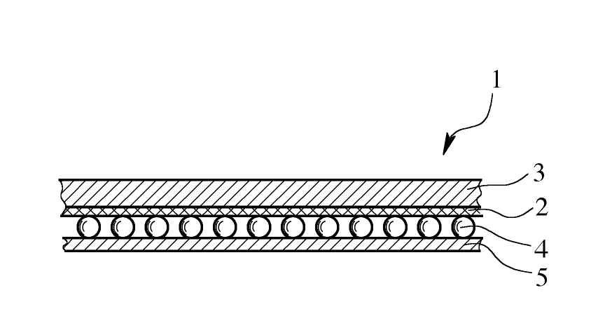

### DETAILED DESCRIPTION OF THE INVENTION

The present invention—in accordance with a first aspect of the present invention—accordingly provides a functional protective material, more particularly with protective function with regard to chemical and/or biological poisons and/or noxiants, such as warfare agents, wherein said functional protective material comprises a multilayered construction, said multilayered construction including a sheetlike, more particularly textile supporting material and a membrane assigned to, more particularly bonded to, said supporting material. In the functional protective material of the present invention, the membrane is endowed with a reactive additization, more particularly with a catalytically active component, preferably having reactivity with regard to chemical and/or biological poisons and/or noxiants.

The fundamental idea of the present invention thus consists in endowing protective materials of multilayered construction with an increased or improved protective performance with regard to chemical and/or biological poisons or noxiants, more particularly warfare agents, by providing a membrane having a reactive additization, more particularly having a catalytically active component, so that—as a crucial difference from the prior art—the reactive additization or the catalytically active component is a constituent part of a membrane acting as blocking layer and therefore what is realized according to the present invention is a way to degrade poisonous and/or noxiant agents prior to any adsorption layer.

What the present invention has therefore succeeded in, in a completely surprising manner, is to enhance the protective performance with regard to chemical and/or biological poisons and/or noxiants through the purposive use of a membrane having reactive additization while at the same time, owing to the high water vapor transmission rate of the membrane acting as blocking layer, the wearing comfort of protective apparel manufactured using the protective material of the present invention is high, so that even severe physical exertion on the part of the wearer of the protective apparel, for example in military deployment, does not give rise to any heat build-up.

The present invention has therefore succeeded in combining in one material the diametrically opposite properties of a high protective performance on the one hand and of a high wearing comfort on the other.

It is a further crucial advantage of the present invention that chemical and/or biological poisonous and/or noxiant agents are degraded and/or decomposed by the adsorptive filtering material of the present invention, so that no harmful agents remain on the protective material of the present invention after use, whereas in the case of membrane systems of the prior art, which only have a barrier function, the noxiant agents stay on the surface and remain a contamination and/or endangering risk (for example as the wearer takes the protective apparel off). Also, as a result, the protective material of the present invention can be used repeatedly without it having to be decontaminated, since it is engineered to be so to speak self-cleaning or self-decontaminating.

The present invention provides a decisive improvement in protective performance with regard to chemical and biological poisonous and warfare agents by additizing the membrane provided for the protective material of the present invention with reactive components or with catalytically active components. This is because the reactive-additization membrane used in the context of the protective material of the present invention has—as a fundamental difference to the membrane systems of the prior art—a high protective performance also with regard to small, highly toxic gas molecules, such as hydrocyanic acid and chlorine gas. Without wishing to be tied to any one theory, this is believed to be because more particularly the reactive or catalytic activity of the membrane causes the toxic substances to be destroyed or degraded even as they encounter the membrane. On the other hand, it can be provided in this context according to the present invention that the resulting reaction products—in the case of a herein preferred use of a microporous membrane having reactive additization—collect at or in the pores in the microporous membrane and cause them to plug up, so that even in the event of any exhaustion of the reactive properties of the membrane a breakthrough of noxiant and/or poisonous agents is effectively prevented, so that in the event of exhaustion of the reactive or catalytically active sites no molecules can pass through the membrane.

The present invention also surprisingly provides a functional protective material that offers improved protective performance with regard to chemical poisons and/or noxiant agents as well as with regard to biological poisons and/or noxiant agents. The protective material of the present invention thus offers effective protection with regard to chemical poisons and/or noxiant agents, more particularly chemical warfare agents (“C weapons”, such as sarin, Hd, soman, hydrocyanic acid, chlorine, etc) but also with regard to biological poisons and/or noxiant agents (“B weapons”, such as viruses, bacteria, fungi, microorganisms, etc, examples being anthrax, smallpox, Ebola, plague, Marburg virus, etc).

Owing to the concept of the present invention, whereby it is the membrane and not some optional adsorption layer, based on activated carbon for example, which is additized with the reactive or catalytically active component, a multiplicity of further advantages are achieved. First, costly and inconvenient impregnation of the adsorption layer, more particularly the activated carbon, is obviated. Consequently, the adsorption capacity of any adsorption layer is not impaired or reduced by the catalytically active component. Secondly, the manufacturing operation for the optional adsorption layer, more particularly the manufacture of activated carbon, is not impaired by the presence of the catalytically active component. Thirdly, it is simpler in production-engineering terms to fit the investment of the membrane with the catalytically active component or with the reactive component into the production line of the entire manufacturing operation for the resulting protective material, since the additizing with the reactive or catalytically active component can take place independently of the manufacture of the adsorption layer. Moreover, the present invention provides for an additization with the reactive or catalytically active component that, compared with such an additization of adsorption materials, requires significantly smaller amounts of impregnant, which contains the catalytically active or reactive component, so that the manufacturing operation for the protective material of the present invention is optimized under cost-specific viewpoints as well.

The present invention thus succeeds altogether in significantly increasing the protective performance of the protective material with regard to chemical and/or biological poisonous and/or noxiant agents, such as warfare agents, through a specific additization or doping or impregnation or investment of an air-impervious but water-vapor-pervious membrane with a reactive or catalytically active component.

Compared with adsorptive filtering materials of the prior art, the protective performance of the adsorptive filtering material of the present invention is accordingly distinctly improved, as demonstrated more particularly by the lower number of breakthrough rates in the course of the Applicant measurements cited hereinbelow.

Altogether, the conception of the protective material of the present invention is associated with a multiplicity of advantages, of which the aforementioned advantages are only mentioned by way of example.

The reactive additization or the catalytically active component with which the membrane is endowed may in the context of the present invention comprise a substance which leads to chemical and/or biological poisons and/or noxiants being rendered harmless. This can take the form for example of a chemical reaction with the poisonous or noxiant agent, in which case the resulting reaction products—as previously mentioned—then occasionally remain on the membrane and, more particularly, lead to a plugging or blinding or obstructing of any pores/micropores present in the membrane, so that further penetration of toxic compounds through the membrane is additionally prevented in this way. In this case, the membrane maintains its protective function with regard to poisonous and/or noxiant agents even when the reactive additization is exhausted.

The reactive additization, more particularly the catalytically active component, may comprise for example a catalyst which induces/causes the decomposition/degradation of poisonous/warfare agents impinging on the membrane, the catalyst as such emerging at least essentially unchanged from the degradation reaction, so that the catalytic activity of the membrane is thereby virtually inexhaustible. In this case too, the nontoxic degradation/reaction products which emerge from the decomposition of the poisonous/noxiant agents can remain on the membrane and, if a microporous membrane is used, lead to a blockage of the membrane pores, so that the passage therethrough of further noxiants is prevented. The membrane of the functional protective material of the present invention thus altogether acts as a barrier/blocking layer with regard to poisonous/noxiant agents having poisonous/noxiant agent degradation properties. Therefore, the membrane is at least essentially impervious to poisonous/noxiant agents or effects an at least lasting retardation of the passage therethrough of poisonous/noxiant agents. The protective effect extends generally to poisonous/noxiant agents in the form of aerosols and/or liquids and/or in the form of gases in that the reactive additization—when a microporous membrane is used—also leads to an outstanding blocking function in relation to small, more particularly toxic gas molecules, such as hydrocyanic acid, chlorine and the like.

Altogether, the reactive additization/catalytically active component thus leads to chemical/biological poisons/noxiants impinging on the membrane or on the present invention protective material being rendered harmless or degraded. It may be contemplated in the context of the present invention that the reactive additization or the catalytically active component itself participates as a co-reactant in the reaction to disarm chemical/biological poisons/noxiants and more particularly emerges irreversibly from the reaction such that the reactive additization or the catalytically active component becomes part of the reaction product or products. On the other hand, it may be contemplated according to the present invention for the reactive additization or the catalytically active component to induce/promote/speed the disarming/degradation of chemical/biological poisons/noxiants landing on the membrane or on the protective material of the present invention in the manner of a catalyst in particular, in which case the reactive additization or the catalytically active component emerges reversibly from the underlying reaction in an at least essentially unchanged state, so that, as mentioned above, this virtually never exhausts the activity of the membrane or of the protective material according to the present invention with regard to the disarming/degrading of toxic substances, more particularly the catalytic activity.

The amount of reactive additization, more particularly of catalytically active component, based on the membrane, should be in the range from 0.1·10⁻⁴ % to 20 % by weight, more particularly in the range from 0.5·10⁻⁴ % to 10 % by weight, preferably in the range from 0.1·10⁻³ % to 8 % by weight, more preferably in the range from 0.5·10⁻³ % to 6 % by weight and yet more preferably in the range from 0.1·10⁻² % to 5 % by weight. In relation to the present invention protective material as such, the amount of reactive additization, more particularly of catalytically active component, should be in the range from 0.1·10⁻⁵ % to 15 % by weight, more particularly in the range from 0.5·10⁻⁵ % to 10 % by weight, preferably in the range from 0.1·10⁻⁴ % to 8 % by weight, more preferably in the range from 0.5·10⁻⁴ % to 5 % by weight and even more preferably in the range from 0.1·10⁻³ % to 2 % by weight. It can be envisaged according to the present invention to depart from the aforementioned amounts for a particular application or on a one-off basis without going outside the scope of the present invention.

In an embodiment of the present invention, the reactive additization, more particularly the catalytically active component, is based on a metal or a metal compound, more particularly based on a metal oxide. In this context, it is possible to combine different metals/different metal compounds with each or one another. The metal or metal compound can be formed for example from the group consisting of copper, silver, cadmium, platinum, palladium, rhodium, zinc, mercury, titanium, zirconium and/or aluminum and also their ions and/or salts and also their respective combinations. For example, the reactive additization, more particularly the catalytically active component, may be selected from the group consisting of Ag, Ag2O, Cu, Cu₂O and CuO and also mixtures thereof. The reactive additization or the catalytically active component is more particularly chromium free.

In general, in the realm of the present invention, the reactive additization, more particularly the catalytically active component, may comprise elemental/atomic or ionic components. Similarly, the reactive additization, more particularly the catalytically active component, may be present in the form of a compound or of a molecule or of a complex.

In a manner which is preferred according to the present invention, the reactive additization, more particularly the catalytically active component, should comprise at least two of the metals from the group consisting of copper, silver, zinc and molybdenum and/or their compounds. This is because the Applicant has determined, surprisingly, that a combination of at least two metals from the aforementioned group leads to particularly good results in respect of the protective function with regard to poisonous/noxiant agents, as will be shown hereinbelow by reference to illustrative embodiments. In this context, the protective properties can be further improved when the reactive additization of the aforementioned kind is optionally present together with triethylenediamine (TEDA) and/or an organic acid and/or sulfuric acid and/or sulfuric acid salts.

Particularly good results in respect of the protective function with regard to chemical/biological poisonous/warfare agents are also obtainable according to the present invention when the reactive additization, more particularly the catalytically active component, is based on a combination of

(i) copper, more particularly copper(II) carbonate (CuCO₃);

(ii) silver, more particularly elemental silver;

(iii) zinc, more particularly zinc(II) carbonate (ZnCO₃);

(iv) molybdenum, more particularly ammonium dimolybdate.

In the aforementioned reactive additization based on copper, silver, zinc and molybdenum, the amount ratio of copper/silver/zinc/molybdenum should be 1.0-10.0/0.01-2.0/1.0-10.0/0.2-8.0, more particularly 3.0-6.0/0.02-0.5/3.0-6.0/0.5-3.0, and preferably about 5/0.05/5/2.

The aforementioned reactive additization, more particularly the catalytically active component, based on copper, silver, zinc and molybdenum may additionally contain (v) triethylenediamine (TEDA), more particularly wherein the amount ratio of copper/silver/zinc/molybdenum/triethylenediamine may be 1.0-10.0/0.01-2.0/1.0-10.0/0.2-8.0/0.3-9.0, more particularly 3.0-6.0/0.02-0.5/3.0-6.0/0.5-3.0/1.0-4.0, and preferably about 5/0.05/5/2/3. However, it can be envisaged according to the present invention to depart from the aforementioned amounts/amount ratios for a particular application or on a one-off basis without going outside the realm of the present invention.

In a further embodiment preferred according to the present invention, the reactive additization, more particularly the catalytically active component, may be based on a combination of

(i) sulfuric acid and/or sulfuric acid salt, more particularly selected from the group consisting of copper sulfates, zinc sulfate and ammonium sulfates;

(ii) molybdenum, more particularly selected from the group consisting of molybdenum oxides, molybdates and hexavalent molybdenum oxyanions;

(iii) copper, more particularly selected from the group consisting of copper oxides, copper carbonates and copper-ammonium complexes, and/or zinc, more particularly selected from the group consisting of zinc oxides, zinc carbonates and zinc-ammonium complexes.

The respective amount ratios of sulfuric acid/molybdenum/copper and/or zinc should be 1.0-15.0/1.0-15.0/1.0-25.0, and more particularly 2.0-10.0/2-10.0/2.0-20.0. Again, this embodiment preferred according to the present invention can be envisaged to depart from the aforementioned amounts/amount ratios for a particular application or on a one-off basis without going outside the realm of the present invention.

In yet a further embodiment preferred according to the present invention, the reactive additization, more particularly said catalytically active component, may be based on a combination of

(i) copper, more particularly selected from the group consisting of copper oxides, copper carbonates, copper sulfates and copper-ammonium complexes;

(ii) zinc, more particularly selected from the group consisting of zinc oxides, zinc carbonates, zinc sulfate and zinc-ammonium complexes;

(iii) optionally silver, more particularly elemental silver;

iv) tetraethylenediamine (TEDA).

The aforementioned impregnation comprises a Cu—Zn-TEDA impregnation which may optionally additionally contain silver (Cu—Zn—Ag-TEDA) and/or molybdenum, more particularly selected from the group consisting of molybdenum oxides, molybdates and hexavalent molybdenum oxyanions.

The respective amount ratio of copper/zinc/silver/tetraethylenediamine should be 1.0-20.0/0.5-18.0/0-15.0/0.1-10.0, more particularly 3.0-15.0/1.0-15.0/0.0-12.0/1.0-8.0, and preferably about 5/0.05/5/2. In this regard too it can be envisaged according to the present invention to depart from the aforementioned amounts for a particular application or on a one-off basis without going outside the realm of the present invention.

The aforementioned reactive additizations may comprise particularly so-called ABEK additizations/impregnations which have a catalytic/degrading effect with regard to specific toxic substances. In this connection, type A relates for example to certain organic gases and vapors having a boiling point >65° C., for example cyclohexane. Type B relates to certain inorganic gases and vapors, for example hydrogen cyanide. Type E relates to a degrading/protecting effect with regard to sulfur dioxide and other acidic gases and vapors. Type K finally relates to a protective function with regard to ammonia and organic ammonia derivatives. For further information, see the respective European standard EN 14387 (January 2004).

As previously mentioned, it can be contemplated according to the present invention for the ABEK type impregnations to be combined with a TEDA impregnation/additization (ABEK-TEDA), in which case the thus additized protective materials of the present invention also have a protective function with regard to cyanogen chloride. The additization of the protective materials of the present invention with a TEDA impregnation also leads to a very good aging stability for the impregnation or the reactive additization as a whole.

The reactive additization, more particularly the catalytically active component, with which the membrane of the protective material of the present invention is additized thus makes it possible—as previously mentioned—for the chemical and/or biological poisons and/or noxiants to be degraded/neutralized. In addition, the reactive additization of the membrane can be adjusted such that the resulting protective material of the present invention further has a biostatic and/or biocidal effect, more particularly a bacteriostatic or bactericidal and/or virostatic or virocidal and/or a fungistatic or fungicidal effect. In this connection, the reactive additization may also contain silver nitrate for example as well as the aforementioned components.

Endowing the membrane used for the protective material of the present invention with the reactive additization, more particularly with the catalytically active component, can be effected using processes well-known to a person skilled in the art from the prior art.

In the present invention, the membrane can be more particularly endowed with the reactive additization, more particularly with the catalytically active component, after its production, more particularly wherein the endowing of the membrane with the reactive additization, more particularly with the catalytically active component, can be effected plasma-chemically, more particularly by means of sputtering, and/or wet-chemically, more particularly by means of spraying and/or vapor deposition, and/or by means of gas phase deposition. In this regard, chemical and/or physical gas phase deposition processes can be used.

However, according to the present invention it is also possible for the membrane to be more particularly endowed with the reactive additization, more particularly with the catalytically active component, during its production, in which case more particularly the endowing of the membrane with the reactive additization, more particularly with the catalytically active component, is effected by means of interpolymerization and/or incorporation in the polymer matrix of the membrane. This can take place in the presence of a catalyst for example.

In general, impregnation processes known per se can be used (for example impregnation with subsequent oxidation/reduction). Processes of this kind are also known per se to a person skilled in the art.

The membrane used for the protective material of the present invention may be porous, more particularly microporous, in an embodiment particularly preferred according to the present invention. This is because such a membrane has a high water vapor transmission rate and hence a high breathability, leading to a high wearing comfort for the resulting protective material of the present invention. Owing to the membrane being endowed according to the present invention with a reactive additization, more particularly as previously defined, the membrane as such simultaneously has a high blocking performance with regard to chemical and/or biological poisonous/warfare agents, in that more particularly a passage of small toxic molecules, such as hydrocyanic acid or chlorine gas, through the membrane is prevented. The membrane of the protective material of the present invention should further accordingly have pores, more particularly micropores. In this connection, the pores, more particularly micropores, should have a diameter in the range from 0.001 to 5 μm, more particularly in the range from 0.005 to 2 μm, preferably in the range from 0.01 to 1 μmm and more preferably in the range from 0.05 to 0.5 μm.

According to the present invention, the reactive additization, more particularly the catalytically active component, may be localized in the region of the pores, more particularly in the region of the micropores, in the membrane. In this regard, the reactive additization, more particularly the catalytically active component, may be localized in the pores, more particularly in the micropores, in the membrane. The pores, more particularly the micropores, in the membrane can thus each include at least one reactive additization, more particularly catalytically active component. In this connection, a multiplicity of the pores/micropores or at least essentially every pore/micropore in the porous, more particularly microporous, membrane should be endowed with the reactive additization, more particularly the catalytically active component. In this regard, the reactive additization or the catalytically active component may be present for example in the form of at least one atom, ion, molecule or at least one complex in the region of the pore/micropore and/or in the pore/micropore. Similarly, the reactive additization, more particularly the catalytically active component, may be disposed on the surface of the membrane and/or incorporated in the membrane matrix.

The total area of the pores, more particularly micropores, in the membrane should be in the range from 0.1 to 60 %, more particularly in the range from 0.5 to 50 %, preferably in the range from 1 to 40 %, more preferably in the range from 2 to 30 % and even more preferably in the range from 5 to 25 %, based on the surface area of the membrane.

The density of the pores, more particularly micropores, should in this context be in the range from 1·10¹ to 1·10⁶ pores/mm², more particularly in the range from 1·10² to 1·10⁵ pores/mm² and preferably in the range from 1·10² to 1·10⁴ pores/mm², based on the surface area of the membrane.

The aforementioned values concerning the pores/micropores ensure altogether a high water vapor transmission rate and thus a high wearing comfort for the resulting protective material of the present invention, while at the same time effectively controlling the passage of toxic substances, more particularly in connection with the reactive additization.

It may be advantageously envisaged in the realm of the present invention—as previously mentioned—for at least essentially all pores each to include or be additized with at least one unit, more particularly at least one molecule, of the reactive additization or of the catalytically active component. This provides particularly effective protection with regard to chemical/biological poisons/noxiants.

The membrane should have a thickness in the range from 1 to 500 μm, more particularly in the range from 1 to 250 μm, preferably in the range from 1 to 100 μm, more preferably in the range from 1 to 50 μm, even more preferably in the range from 2.5 to 30 μm and yet even more preferably in the range from 5 to 25 μm.

In this context, the membrane should have a basis weight in the range from 0.5 to 100 g/m², more particularly in the range from 1 to 35 g/m² and preferably in the range from 2 to 25 g/m².

2 5 It can similarly be envisaged to construct the membrane to have one or more layers, in which case it can be envisaged in this regard for the membrane to be present as a composite or as a multilayered laminate. The respective layers of the membrane may consist of different materials or include different materials.

For example, the membrane may comprise or consist of a plastic and/or a polymer, in which case more particularly the plastic and/or the polymer is selected from the group consisting of polyurethanes, polyether amides, polyester amides, polyether esters, polytetrafluoroethylenes and/or cellulose-based polymers and/or derivatives of the aforementioned compounds, preferably polyether esters and more preferably polytetrafluoroethylenes.

The membrane of the protective material of the present invention should further be at least essentially water impervious and/or at least essentially air impervious.

Moreover, the membrane of the protective material of the present invention, as previously mentioned, should be breathable, more particularly water vapor pervious.

The bonding of the membrane to the supporting material of the protective material of the present invention should be at least essentially uniform. However, according to the present invention, the membrane may also preferably be bonded sectionally, more particularly punctiformly, to the supporting material. More particularly, the membrane can thus be laminated onto the supporting layer by means of a preferably punctiformly applied adhesive. The supporting layer acts as a quasi carrier layer for the membrane and enhances the mechanical stability and tensile strength of the membrane. Useful adhesives for the present invention in this connection include conventional adhesives, for example polyurethane-based adhesives or the like.

The supporting material used according to the present invention can be a woven fabric, a loop-formingly knitted fabric, a loop-drawingly knitted fabric, a nonwoven scrim, a batt or a bonded textile fabric. In addition, the supporting material can have a basis weight in the range from 20 to 250 g/m², more particularly in the range from 30 to 150 g/m² and preferably in the range from 40 to 120 g/m². The supporting material should be abrasion resistant and more particularly consist of an abrasion-resistant textile material. In addition, to further enhance the protective performance with regard to chemical and biological poisonous/noxiant agents, the supporting material can be hydro- and/or oleophobicized and/or plasma treated.

The supporting material constitutes the covering layer and in the donned or use state of the resulting protective material of the present invention is preferably disposed on the wearer-remote side of the membrane. The supporting material may include or consist of natural and/or manufactured fibers. The supporting material preferably consists of manufactured fibers, more preferably from the group consisting of polyamides, polyesters, polyolefins, polyurethanes, polyvinyl (for example polyvinyl alcohols) and/or polyacrylic.

As previously mentioned, the supporting material may be oleo- and/or hydrophobicized, more particularly in order that in the event of relatively large drops of noxiant and poisonous agents impinging these be distributed on the surface of the protective material of the present invention, or in order to let them “bead off” the surface; oleo- and hydrophobicizing agents suitable for this purpose are well known to a person skilled in the art (examples being fluoropolymers, such as fluorocarbon resins). The supporting material can further be additized with a flame retardant (for example with a phosphoric ester). The supporting material may further be antistaticized. Furthermore, the supporting material can also be provided with a camouflage print, more particularly in the course of the manufacture of NBC protective suits.

The supporting material used in the realm of the present invention should have a thickness or to be more precise cross-sectional thickness in the range from 0.05 to 5 mm, preferably in the range from 0.1 to 1 mm and more particularly in the range from 0.2 to 0.5 mm.

In a further embodiment preferred according to the present invention, the protective material according to the invention may include an adsorption layer based on an adsorption material adsorbing more particularly chemical and/or biological poisons and/or noxiants, in which case more particularly the adsorption layer is assigned to that side of the membrane which faces away from the supporting material. The purposive additization of the protective material of the present invention with an additional adsorption layer has the effect of yet further improving the protective effects as a whole. In this connection, the membrane should be disposed in the donned state on that side of the adsorption layer which faces the noxiant source/exposure, so that the membrane acts as a barrier layer in front of the adsorption layer. This has the advantage that a large proportion of the poisonous/noxiant agents are kept away from the adsorption layer by the membrane and therefore the adsorption layer is virtually inexhaustible. The use of an adsorption layer also has the advantage that even in the event of very high noxiant concentrations, more particularly when the membrane incurs damage due to mechanical influences, poisonous/noxiant agents penetrating into the protective material can be effectively adsorbed. The membrane can similarly act as a supporting material for the adsorption layer, in which case the adsorption layer can be bonded to the membrane by means of a punctiform or a point grid application of adhesive for example. This results in a high accessibility of the adsorbents for the poisonous/noxiant agents to be adsorbed, in particular when at least 30 %, more particularly at least 40 %, preferably at least 50 % and more preferably at least 70 % of the surface of the adsorbents is freely accessible to the poisonous/noxiant agents, i.e., not covered with adhesive.

The adsorption material of the adsorption layer may be a material based on activated carbon, more particularly in the form of activated-carbon particles or activated-carbon fibers.

The use of activated carbon as adsorption material also has the advantage that the buffering effect of the activated carbon serves to additionally improve the wearing comfort in that the activated carbon serves as a moisture/water store or buffer (for perspiration for example).

The adsorption layer is preferably constructed as an adsorption sheet filter. The adsorption layer may comprise by way of adsorption material discrete particles of activated carbon, preferably in granule form (“granulocarbon”) or sphere form (“spherocarbon”), wherein the average diameter of the activated-carbon particles may be less than 1.0 mm, preferably less than 0.8 mm and more preferably less than 0.6 mm.

Granulocarbon, more particularly spherocarbon has the decisive advantage that it is supremely abrasion resistant and very hard, which is very important in relation to the wear-and-tear properties. Preferably, the bursting pressure of an individual activated-carbon particle, more particularly activated-carbon granule or spherule, is generally at least about 5 N, more particularly at least about 10 N, and can be up to about 20 N. In this embodiment, the amount in which the activated-carbon granules are applied to the membrane or any optional further supporting material is generally in the range from 5 to 500 g/m², more particularly in the range from 10 to 400 g/m², preferably in the range from 20 to 300 g/m² and more preferably in the range from 25 to 250 g/m².

In an alternative embodiment, the adsorption layer may comprise by way of adsorption material activated-carbon fibers, more particularly in the form of an activated-carbon fabric. Activated-carbon fabrics of this kind may have for example a basis weight in the range from 20 to 200 g/m², more particularly in the range from 50 to 150 g/m². These activated-carbon fabrics may comprise for example a woven, loop-formingly knitted, nonwoven-scrim or bonded activated-carbon fabric, for example based on carbonized and activated cellulose and/or a carbonized and activated acrylonitrile.

It is similarly possible in the realm of the present invention to combine activated-carbon particles on the one hand and activated-carbon fibers on the other to form the adsorption layer. In this connection, activated-carbon particles form the advantage of a higher adsorption capacity, while activated-carbon fibers have superior adsorption kinetics.

The activated carbon used according to the present invention preferably has an internal surface area (BET) of at least 800 m²/g, more particularly at least 900 m²/g and preferably at least 1000 m²/g and more preferably in the range from 800 to 2000 m²/g.

In the realm of the present invention, a spacer layer may also be disposed between the membrane and the adsorption layer and it may take the form for example of a batt (nonwoven), of a thin layer of foamed plastic or of a textile fabric (a loop-formingly knitted fabric for example). The additional spacer layer has the advantage of reducing the mechanical loading of the adsorption layer on the one side and the membrane on the other since an additional layer between the membrane on the one side and the adsorption layer on the other is able to absorb or cushion mechanical stresses. When a spacer layer is used, the adsorption layer may be more particularly bonded to the spacer layer by means of a point grid application of adhesive. In addition, on that side which faces away from the adsorption layer, the spacer layer can similarly be bonded to the membrane in point grid fashion. The basis weight of the spacer layer should be in the range from 5 to 100 g/m², more particularly in the range from 10 to 75 g/m² and preferably in the range from 15 to 50 g/m².

It may similarly be envisaged in the realm of the present invention for the protective material to include an inner layer, more particularly an inner lining. In this case, the inner layer can be assigned to that side of the membrane which faces away from the supporting material. In this connection, the inner lining can be more particularly adhered in point grid fashion to the membrane provided no adsorption layer is used. When an additional adsorption layer is used, the inner lining can be mounted on that side of the adsorption layer which is opposite the membrane, in which case a more particularly point-grid adhesive bond can also be provided in this regard. The use of an inner layer, provided no additional adsorption layer is provided, similarly leads to a protective function with regard to the membrane. When an adsorption layer is used, the adsorption layer is additionally protected from contamination due to the wearer, such as perspiration for example. Thus the efficiency of the adsorption layer is also enhanced in this way. In addition, the inner layer, which faces the wearer in the donned state, enhances the wearing comfort, more particularly the wearer's experience of the protective material of the present invention is soft.

It can be envisaged according to the present invention for the inner layer to be configured in the form of a textile fabric. For example, the inner layer can be a woven fabric, a loop-formingly knitted fabric, a loop-drawingly knitted fabric, a nonwoven scrim, a bonded textile fabric or a batt. Useful materials in this regard include the materials already mentioned above for the supporting material. The inner layer should have a basis weight in the range from 5 to 100 g/m², more particularly in the range from 10 to 75 g/m² and preferably in the range from 15 to 50 g/m².

The protective material as a whole may have an overall basis weight in the range from 150 to 1000 g/m², more particularly in the range from 200 to 800 g/m², preferably in the range from 250 to 600 g/m² and more preferably in the range from 300 to 500 g/m². In addition, the protective material should have a thickness or to be more precise an overall cross-sectional thickness in the range from 0.1 mm to 20 mm, more particularly in the range from 0.5 mm to 15 mm, preferably in the range from 1 mm to 10 mm and more preferably in the range from 2 mm to 5 mm.

It is particularly advantageous for the protective material of the present invention at 25° C. and at a 50 μm thickness of the membrane to further have a water vapor transmission rate of at least 10 l/m² per 24 h, more particularly at least 15 l/m² per 24 h and preferably at least 20 l/m² per 24 h. In addition, the protective material should have a water vapor transmission resistance Ret under steady-state conditions, measured to DIN EN 31 092:1993 (February 1994) and ISO 11 092, at 35° C., of at most 30 (m²·pascal)/watt, more particularly at most 25 (m²·pascal)/watt and preferably at most 15 (m²·pascal)/watt, at a 50 μm thickness of the membrane. Finally, the protective material of the present invention should have a barrier effect with regard to chemical warfare agents, more particularly bis[2-chloroethyl] sulfide (mustard gas, Hd, Yellow Cross), measured in the diffusive flow test, permitting permeation of at most 4 μmg/cm² per 24 h, more particularly at most 3.5 μmg/cm² per 24 h, preferably at most 3.0 μmg/cm² per 24 h and even more preferably at most 2.5 μmg/cm² per 24 h, at a 50 μm thickness of the membrane. The diffusive flow test is known per se to a person skilled in the art and is also further elucidated in the context of the illustrative embodiments.

Further advantages, properties, aspects and features of the present invention will become apparent from the following description of an operative example depicted in the single figure.

The figure shows a schematic sectional view through the layered construction of a present invention protective material according to an embodiment of the present invention whereby the present invention protective material, in addition to the membrane and the supporting material, includes an adsorption layer and also an inner layer.

The figure shows a schematic sectional view of the inventive functional protective material 1, more particularly having protective performance with regard to chemical and/or biological poisons and/or noxiants, such as warfare agents. The functional protective material 1 according to the invention comprises a multilayered construction, said multilayered construction including a sheetlike, more particularly textile supporting material 3 and a membrane 2 assigned to and more particularly connected to the supporting material 3. The membrane 2 is endowed with a reactive additization, more particularly with a catalytically active component, preferably having reactivity with regard to chemical and/or biological poisons and/or noxiants. The figure further shows the additization of the inventive protective material with a previously defined optional adsorption layer 4 which has been applied to the membrane 2. Finally, the figure reveals the inventive embodiment whereby the inventive protective material is optionally provided with an inner layer 5 facing the wearer in the donned state. The mechanical, physical and/or chemical properties of the aforementioned layers or plies or of the inventive protective material 1 per se can be referenced to the above observations, which apply mutatis mutandis in relation to this specific elaboration.

The present invention further provides—in accordance with a second aspect of the present invention—a membrane, more particularly having protective function with regard to chemical and/or biological poisons and/or noxiants, such as warfare agents, wherein said membrane is endowed with a reactive additization, more particularly with a catalytically active component, preferably having reactivity with regard to chemical and/or biological poisons and/or noxiants. The membrane of the present invention is notable for a high protective performance with regard to chemical/biological poisonous/noxiant agents since, owing to the reactive additization or endowment of the membrane of the present invention with a catalytically active component, poisonous/noxiant agents are degraded in an effective manner. In an embodiment preferred according to the present invention, the membrane according to the invention comprises a porous, more particularly microporous membrane. In this respect, the membrane may be additized with the reactive additization or the catalytically active component such that the degradation products of the chemical poisonous/noxiant agents or the reaction products emanating from the degradation reaction lead to an occlusion of the pores or micropores, which prevents or reduces any passage of poisonous or noxiant agents through the membrane even after exhaustion of the reactive additization or of the catalytically active component. The membrane of the present invention combines altogether a high protective performance on the one hand with a high breathability on the other in a single material, so that the membrane of the present invention is more particularly suitable for use in protective articles, more particularly for NBC protective apparel.

For further details concerning the membrane of the present invention, reference may be made to the above observations concerning the membrane used for the protective material of the present invention, which apply mutatis mutandis in this regard.

The present invention further provides—in accordance with a third aspect of the present invention—the use of the protective material of the present invention, as described above, or of the membrane of the present invention, as described above, in the manufacture of protective articles of any kind, more particularly in the manufacture of protective apparel, more particularly for the civil or military sector, such as protective suits, protective gloves, protective footwear, protective socks, protective headgear and the like, and of protective covers of any kind, preferably all aforementioned protective materials for NBC deployment.

Finally, the present invention also provides—in accordance with a fourth aspect of the present invention—protective articles, more particularly for the civil or military sector, more particularly protective apparel, such as protective suits, protective gloves, protective footwear, protective socks, protective headgear and the like, and also protective covers such as tents, sleeping bags, preferably all aforementioned protective materials for NBC deployment, obtained using the protective material of the present invention, as previously defined, or including a protective material according to the invention, as previously defined, and/or obtained using a membrane according to the invention, as previously defined, and/or including a membrane according to the invention, as previously defined.

The present invention is thus altogether the first to succeed in providing a protective material or an adsorptive filtering material which by virtue of the specific endowment of the membrane with a reactive additization or a catalytically active component that is reactive or catalytically active in relation to chemical/biological poisons/warfare agents provides an effective protection with regard to chemical and biological poisonous and warfare agents—and all that combined with high water vapor perviousness.

Further elaborations, modifications and variations of the present invention are readily apparent to and realizable by the ordinarily skilled on reading the description without their having to go outside the realm of the present invention.

The present invention is illustrated with reference to the following operative examples which, however, shall not in any way restrict the present invention.

### OPERATIVE EXAMPLES

Ten different protective materials are produced: Noninventive adsorptive filtering materials are produced in a first complex (Examples No. 1 and No. 2):

1. A comparative protective material (Example No. 1) which includes a microporous PTFE membrane having a thickness of about 25 μm is produced first. The membrane as per this comparative example is not additized with a reactive endowment. The membrane is mounted on or to be more precise adhered in point grid fashion to a supporting material based on manufactured fibers. The supporting material in the form of a woven fabric has a basis weight of 100 g/m².

2. A further comparative protective material (Example No. 2) is produced by including an adsorption layer based on activated carbon in addition to Example No. 1, wherein the activated carbon has been applied, by means of a point grid adhesive bond, to that side of the membrane which faces away from the supporting material. The activated carbon used for the adsorption layer is spherical with an average diameter of less than 0.8 mm. The additization with activated carbon is effected with a 200 g/m² add-on rate for the activated carbon.

A second complex (Examples No. 3 and No. 4) comprises producing inventive adsorptive filtering materials which include membranes having various reactive additizations or catalytically active components. The membranes used in this regard are microporous PTFE membranes having a thickness of about 25 μm, which after additization with the reactive components have been applied in point grid fashion to a woven fabric based on manufactured fibers having a basis weight of 100 g/m². The total amount of reactive additization or catalytically active components is 0.2 % by weight, based on the membrane, in each of the examples which follow. When more than one component or to be more precise more than one metal is used in respect of the reactive additization, the respective components are present in identical ratios relative to each other.

A copper carbonate is used in relation to the reactive additization based on copper, elemental silver is used in relation to the reactive additization based on silver, a zinc carbonate is used in relation to the reactive additization based on zinc, and ammonium dimolybdate is used in relation to the reactive additization based on molybdenum.

3. Inventive Examples 3 a) to 3 d) utilize the hereinbelow described membranes having reactive additization:

a) Inventive Example 3 a) utilizes a membrane which includes a reactive additization based on copper.

b) Inventive Example 3 b) utilizes a membrane which includes a reactive additization based on two components, namely copper on the one hand and silver on the other.

c) Inventive Example 3 c) utilizes a membrane which includes a combination of four catalytically active components, namely one component each based on copper, silver, zinc and molybdenum.

d) Inventive Example 3 d) utilizes a membrane having a reactive additization based on copper, silver, zinc and molybdenum and additionally containing triethylenediamine (TEDA).

4. A further series of inventive examples utilize a membrane having reactive additization where the resulting protective material additionally includes an adsorption layer. The adsorption layer is applied in point grid fashion to that side of the membrane which faces away from the supporting layer. In this regard, activated carbon in the form of spherocarbon having a diameter of less than 0.8 mm is applied at an add-on rate of 200 g/m². The membranes used in this series include the following reactive additizations:

a) Inventive Example 4 a) utilizes a membrane which includes a reactive additization based on copper.

b) Inventive Example 4 b) utilizes a membrane which includes a reactive additization based on two components, namely copper on the one hand and silver on the other.

c) Inventive Example 4 c) utilizes a membrane which includes a quaternary combination of catalytically active components, namely one component each based on copper, silver, zinc and molybdenum.

d) Inventive Example 4 d) utilizes a membrane having a reactive additization based on copper, silver, zinc and molybdenum and additionally containing triethylenediamine (TEDA).

The membranes produced in this way are investigated in respect of their protective performance with regard to chemical poisonous/warfare agents:

The results hereinbelow relate to the protective performance with regard to chemical warfare agents (mustard gas in this specific instance), the tests being carried out by means of the standardized Laid Drop Diffusive Flow Test. To this end, the adsorptive filtering materials (specimen area: 10 cm² in each case) are clamped in a test cell over a PE membrane (10 μm), which simulates the human skin, and drops of warfare agent (mustard gas in this case, eight drops of mustard gas of 1 μl each in volume per 10 m²) are applied to the upper material or the supporting material using a canula. The air stream underneath the specimen is sucked through a wash bottle. After the test, the cumulative breakthrough is measured in μg/m² by means of gas chromatography; the minimum requirement is a value of <4 μg/m² (test conditions: relative humidity <5 %, temperature 30° C., 6 1/s air stream under the specimen, 24 h test duration). This test simulates the diffusion of liquid warfare agent through the adsorptive filtering material without convection and in the process simulates the flat contact area of protective apparel on the skin, the latter being simulated by the PE membrane. The limit of detection with this method is about 0.05 μg/m².

Table 1 shows the results obtained in this regard for Comparative Examples No. 1 and 2 and for Inventive Examples No. 3 and 4:

| | 1 | 2 | 3 | | | | 4 | | | |
|---|---|---|---|---|---|---|---|---|---|---|
| Example No. | | | a) | b) | c) | d) | a) | b) | c) | d) |
| Mustard gas | >4.2 | 3.9 | 3.5 | 3.0 | 2.5 | 2.1 | 3.2 | 2.4 | 1.8 | 1.7 |
| diffusion | | | | | | | | | | |
| test/cumulative | | | | | | | | | | |
| breakthrough | | | | | | | | | | |
| [μg/cm²] | | | | | | | | | | |

The test results show that the protective performance of the inventive protective materials which contain the inventive membrane having the specific reactive additization, more particularly the catalytically active component, is significantly improved, which documents the superior efficacy of the inventive adsorptive filtering material in relation to the protective performance with regard to chemical poisonous and warfare agents.

The test series illustrates that the protective performance with regard to chemical poisonous/warfare agents can be yet further improved when the protective materials of the present invention are additized with an additional adsorption layer based on activated carbon.

The results thus altogether document the excellent protective performance of the protective material of the present invention, which performance is significantly improved over the prior art.

1. A protective apparel, said protective apparel comprising a functional protective material having protective function with regard to chemical and biological poisons and noxiants,
wherein said functional protective material comprises a multilayered construction, said multilayered construction including:
a sheetlike textile supporting material, wherein said supporting material is a woven fabric, a loop-formingly knitted fabric, a loop-drawingly knitted fabric, a nonwoven scrim, a batt or a bonded textile fabric; and
a membrane associated to said supporting material, wherein said membrane is bonded to said supporting material at least essentially uniformly, or wherein said membrane is bonded to said supporting material sectionally, and
wherein said membrane is endowed with a reactive additization in the form of a catalytically active component having reactivity with regard to chemical and biological poisons and noxiants,
wherein said reactive additization is based on a combination of
(i) copper selected from the group consisting of copper oxides, copper carbonates, copper sulfates and copper-ammonium complexes;
(ii) zinc selected from the group consisting of zinc oxides, zinc carbonates, zinc sulfate and zinc-ammonium complexes;
(iii) optionally elemental silver;
(iv) tetraethylenediamine (TEDA);
(v) molybdenum selected from the group consisting of molybdenum oxides, molybdates and hexavalent molybdenum oxyanions;
wherein the amount of reactive additization, based on said membrane, is in the range from 0.1·10⁻⁴ % to 20 % by weight, and
wherein said membrane is endowed with said catalytically active component after the production of the membrane wherein the endowing of said membrane with said catalytically active component is effected by means of one of plasma-chemically, sputtering, wet-chemically, spraying, vapor deposition and gas phase deposition, or
wherein said membrane includes a polymer matrix and is endowed with said catalytically active component during the production of the membrane, wherein the endowing of said membrane with said catalytically active component is effected by means of interpolymerization or incorporation in the polymer matrix of said membrane; and
wherein the protective material further includes an adsorption layer based on an adsorption material adsorbing chemical and biological poisons and noxiants, wherein said adsorption material of said adsorption layer is a material based on activated carbon.

2. The protective apparel according to claim 1,
wherein the amount of reactive additization, based on said protective material, is in the range from 0.1·10⁻⁵ % to 15 % by weight.

3. The protective apparel according to claim 1,
wherein said reactive additization is based on a combination of
(i) copper as copper(II) carbonate (CuCO₃);
(ii) zinc as zinc(II) carbonate (ZnCO₃);
(iii) silver as elemental silver;
(iv) triethylenediamine (TEDA);
(v) molybdenum as ammonium dimolybdate.

4. The protective apparel according to claim 1, wherein the amount ratio of copper/silver/zinc/molybdenum/triethylenediamine is 1.0-10.0/0.01-2.0/1.0-10.0/0.2-8.0/0.3-9.0.

5. The protective apparel according to claim 1,
wherein said membrane has a thickness in the range from 1 to 500 μm.

6. The protective apparel according to claim 1,
wherein said membrane has a basis weight in the range from 0.5 to 100 g/m².

7. The protective apparel according to claim 1,
wherein said protective material, at 25° C. and at a 50 μm thickness of said membrane, has a water vapor transmission rate of at least 101/m² per 24 h.

8. The protective apparel according to claim 1,
wherein said protective material, at 35° C. and at a 50 μm thickness of said membrane, has a water vapor transmission resistance Rₑₜ under steady-state conditions, measured according to DIN EN 31 092:1993 (February 1994) and ISO 11 092, of at most 30 (m²·pascal)/watt.

9. The protective apparel according to claim 1,
wherein said protective material, at a 50 μm thickness of said membrane, has a barrier effect with regard to the chemical warfare agent bis[2-chloroethyl] sulfide, measured in the diffusive flow test, permitting permeation of at most 4 μmg/cm² per 24 h.

10. The protective apparel according to claim 1,
wherein said protective apparel is selected from the group consisting of protective suits, protective gloves, protective footwear, protective socks, protective headgear and protective covers.

11. A protective apparel, said protective apparel comprising a functional protective material having protective function with regard to chemical and biological poisons and noxiants,
wherein said functional protective material comprises a multilayered construction, said multilayered construction including:
a sheetlike textile supporting material, wherein said supporting material is a woven fabric, a loop-formingly knitted fabric, a loop-drawingly knitted fabric, a nonwoven scrim, a batt or a bonded textile fabric; and
a membrane associated to said supporting material, wherein said membrane is bonded to said supporting material at least essentially uniformly, or wherein said membrane is bonded to said supporting material sectionally, and
wherein said membrane is endowed with a reactive additization in the form of a catalytically active component having reactivity with regard to chemical and biological poisons and noxiants,
wherein said reactive additization is based on a combination of copper as copper(II) carbonate (CuCO3);
(ii) zinc as zinc(II) carbonate (ZnCO3);
(iii) silver as elemental silver;
(iv) tetraethylenediamine (TEDA);
(v) molybdenum as ammonium dimolybdate;
wherein the amount of reactive additization, based on said membrane, is in the range from 0.1·10⁻⁴ % to 20 % by weight, and
wherein said membrane is endowed with said catalytically active component after the production of the membrane wherein the endowing of said membrane with said catalytically active component is effected by means of one of plasma-chemically, sputtering, wet-chemically, spraying, vapor deposition and gas phase deposition, or
wherein said membrane includes a polymer matrix and is endowed with said catalytically active component during the production of the membrane, wherein the endowing of said membrane with said catalytically active component is effected by means of interpolymerization or incorporation in the polymer matrix of said membrane; and
wherein the protective material further includes an adsorption layer based on an adsorption material adsorbing chemical and biological poisons and noxiants, wherein said adsorption material of said adsorption layer is a material based on activated carbon.

12. The protective apparel according to claim 11,
wherein the amount ratio of copper/silver/zinc/molybdenum/triethylenediamine is 1.0-10.0/0.01-2.0/1.0-10.0/0.2-8.0/0.3-9.0.

13. The protective apparel according to claim 11,
wherein said protective material, at 25° C. and at a 50 μm thickness of said membrane, has a water vapor transmission rate of at least 101/m² per 24 h;
wherein said protective material, at 35° C. and at a 50 μm thickness of said membrane, has a water vapor transmission resistance Ret under steady-state conditions, measured according to DIN EN 31 092:1993 (February 1994) and ISO 11 092, of at most 30 (m²·pascal)/watt; and
wherein said protective material, at a 50 μm thickness of said membrane, has a barrier effect with regard to the chemical warfare agent bis[2-chloroethyl] sulfide, measured in the diffusive flow test, permitting permeation of at most 4 μmg/cm² per 24 h.

14. A protective apparel, said protective apparel comprising a functional protective material having protective function with regard to chemical and biological poisons and noxiants,
wherein said functional protective material comprises a multilayered construction, said multilayered construction including:
a sheetlike textile supporting material, wherein said supporting material is a woven fabric, a loop-formingly knitted fabric, a loop-drawingly knitted fabric, a nonwoven scrim, a batt or a bonded textile fabric; and
a membrane associated to said supporting material, wherein said membrane is bonded to said supporting material at least essentially uniformly, or wherein said membrane is bonded to said supporting material sectionally, and
wherein said membrane is endowed with a reactive additization in the form of a catalytically active component having reactivity with regard to chemical and biological poisons and noxiants,
wherein said reactive additization is based on a combination of
(i) copper as copper(II) carbonate (CuCO₃);
(ii) zinc as zinc(II) carbonate (ZnCO₃);
(iii) silver as elemental silver;
(iv) tetraethylenediamine (TEDA);
(v) molybdenum as ammonium dimolybdate;
wherein the amount of reactive additization, based on said membrane, is in the range from 0.1·10⁻⁴ % to 20 % by weight, and
wherein said membrane is endowed with said catalytically active component after the production of the membrane wherein the endowing of said membrane with said catalytically active component is effected by means of one of plasma-chemically, sputtering, wet-chemically, spraying, vapor deposition and gas phase deposition, or
wherein said membrane includes a polymer matrix and is endowed with said catalytically active component during the production of the membrane, wherein the endowing of said membrane with said catalytically active component is effected by means of interpolymerization or incorporation in the polymer matrix of said membrane;
wherein the protective material further includes an adsorption layer based on an adsorption material adsorbing chemical and biological poisons and noxiants, wherein said adsorption material of said adsorption layer is a material based on activated carbon;
wherein said protective material, at 25° C. and at a 50 μm thickness of said membrane, has a water vapor transmission rate of at least 101/m² per 24 h;
wherein said protective material, at 35° C. and at a 50 μm thickness of said membrane, has a water vapor transmission resistance Ret under steady-state conditions, measured according to DIN EN 31 092:1993 (February 1994) and ISO 11 092, of at most 30 (m²·pascal)/watt; and
wherein said protective material, at a 50 μm thickness of said membrane, has a barrier effect with regard to the chemical warfare agent bis[2-chloroethyl] sulfide, measured in the diffusive flow test, permitting permeation of at most 4 μg/cm² per 24 h.

15. The protective apparel according to claim 14,
wherein the amount ratio of copper/silver/zinc/molybdenum/triethylenediamine is 1.0-10.0/0.01-2.0/1.0-10.0/0.2-8.0/0.3-9.0.
